(19) United States
(12) Patent Application Publication
(10) Pub. No.: US 2009/0252229 A1
(43) Pub. Date: Oct. 8, 2009

(54) IMAGE ENCODING AND DECODING

(76) Inventor: Leszek Cieplinski, Guildford (GB)

Correspondence Address: BIRCH STEWART KOLASCH & BIRCH, PO BOX 747, FALLS CHURCH, VA, 22040-0747, US

(21) Appl. No.: 12/373,270

(22) PCT Filed: Jul. 10, 2007
(86) PCT No.: PCT/EP07/57040

§ 371 Date: Jan. 9, 2009

(30) Foreign Application Priority Data
Jul. 10, 2006 (GB) 0613675.8

(51) Int. Cl. H04N 7/26

(52) U.S. Cl. 375/240.16; 375/E07.123

(57) ABSTRACT

An improved MPEG adaptive reference fine granularity scalability encoder and decoder is described. The parameters α and β used to weight difference data during the generation of a prediction error signal in an enhancement layer are modified in dependence upon the magnitude of the values in the difference data.

The present invention relates to the field of image encoding and decoding, and more particularly to the field of video compression encoding and decoding.

Scalable video coding aims to address the diversity of video communications networks and end-user interests, by compressing the original video content in such a way that efficient reconstruction at different bit-rates, frame-rates and display resolutions from the same bitstream is supported. Bit-rate scalability refers to the ability to reconstruct a compressed video over a fine gradation of bit-rates, without loss of compression efficiency. This allows a single compressed bitstream to be accessed by multiple users, each user utilizing all of his/her available bandwidth. Without rate-scalability, several versions of the same video data would have to be made available on the network, significantly increasing the storage and transmission burden. Other important forms of scalability include spatial resolution and frame-rate (temporal resolution) scalability. These allow the compressed video to be efficiently reconstructed at various display resolutions, thereby catering for the different capabilities of all sorts of end-user devices.

The current draft of the emerging scalable video coding standard (which will become ISO/IEC 14496-10/AMD2 and ITU-T Recommendation H.264 annex F; the current draft, Joint Draft 6 can be found in the Joint Video Team document JVT-S201) supports a specific form of bitrate scalability called fine granularity scalability (FGS), which allows the bitstream to be cut at essentially any bitrate. This is achieved by performing the coding of transform coefficients using a form of progressive refinement. This technique orders the coefficient bits in the blocks in a nearly rate-distortion optimal fashion and introduces efficient signalling of the order that the refinements are transmitted in. This means that when some bits are dropped, the remaining bits allow for as good reconstruction of the original block as possible given the number of bits left. A more detailed description of the idea of fine granularity scalability, as implemented in the previous MPEG standard can be found in Overview of Fine Granularity Scalability in MPEG-4 Video Standard by Weipeng Li, published in IEEE Transactions on Circuits and Systems for Video Technology, vol. 11, no. 3, Mar. 2001.

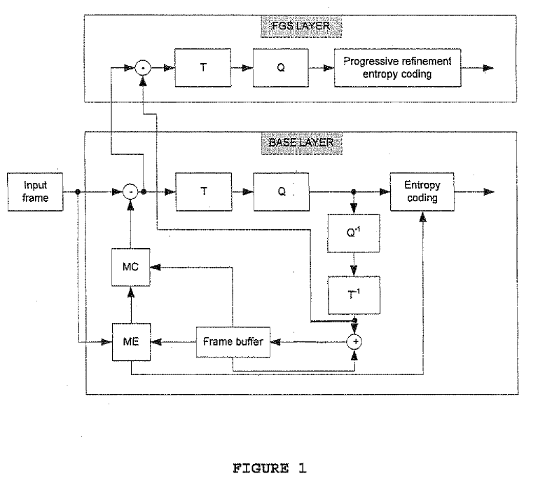

The processing flow for the fine granularity scalability scheme is illustrated in FIG. 1, for the case of a single enhancement layer. The coding process can be considered in two parts. The coding of the base layer follows the familiar pattern for a non-scalable coding as used in e.g. MPEG-4 AVC, where ME stands for motion estimation, MC for motion compensation, T for spatial transform, and Q for quantisation.

For the enhancement (FGS) layer, the difference between the original difference frame and the reconstructed base layer difference frame is transformed using the spatial transform and quantised with the quantisation step equal to half the quantisation step used in the encoding of the base layer. The quantised transform coefficients are then coded using a modified entropy coding technique called progressive refinement, which allows for the enhancement layer bitstream to be cut at an arbitrary point. As defined in the current draft of the MPEG-4 SVC standard, this truncation can be performed in a number of ways:

1. Dropping of whole progressive refinement network adaptation layer (NAL) units corresponding to complete FGS layers. This only applies when multiple FGS layers are used.
2. Simple truncation, where the last progressive refinement NAL unit for the highest spatio-temporal level in the bitstream is truncated by the percentage necessary to satisfy the bitrate constraint.
3. Quality layers, where progressive refinement NAL units are assigned quality layer identifiers which are transmitted either in the NAL units themselves or in a separate message. In this case, instead of truncating only the highest NAL unit, all the NAL units with the maximum possible quality layer identifier are truncated by the same percentage.

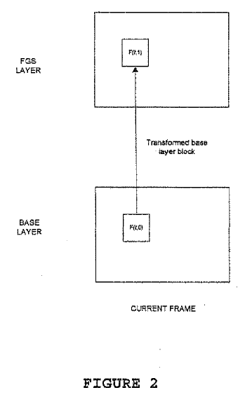

An important point in the scheme described above is that the reference for the motion compensation of both the base layer and enhancement layer is the reconstructed base layer frame. This is illustrated in FIG. 2, where F(t, n) is the transform coefficient value at time t in layer n, and has important consequences, which will be discussed below.

The goal of adaptive-reference fine granularity scalability (AR-FGS) is to improve the performance of FGS for low-delay applications, where only P pictures are used. The problem with FGS in this application scenario is that when the FGS layers are removed from the bitstream in order to adjust the bitrate, an error is introduced due to the use of the resulting frames with degraded reconstruction quality as reference frames for motion compensation. As the motion compensation is repeated, the error accumulates in a process commonly referred to as prediction drift. As noted above, this problem is solved in the “regular” version of FGS coding in the current draft of the MPEG-4 SVC standard by using only base layer reference frame as motion compensation reference. This solution avoids the drift problem but results in reduced compression efficiency.

In “Robust and Efficient Scalable Video Coding with Leaky Prediction”, presented at the IEEE International Conference on Image Processing 2002, Han and Girod proposed to overcome this problem by introducing so-called leaky prediction. This is a modification of the usual motion compensation scheme, in which the prediction signal is formed as a weighted average of the base-layer reference picture and the enhancement layer reference picture. A similar technique has been adopted for the current draft of the MPEG-4 SVC standard (see the Joint Draft version 6 referred to above and also the Joint Scalable Video Model version 6 in the Joint Video Team document JVT-S202). The details of the scheme are different depending on the characteristics of the currently processed base layer block coefficients as described below.

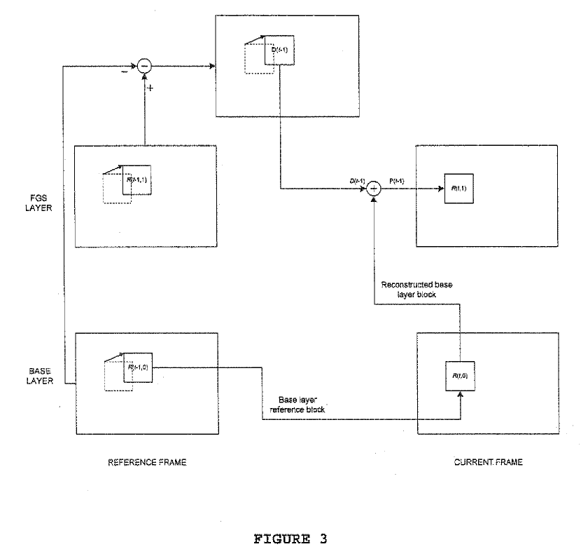

When all coefficients for the current block in the base layer are 0, the processing is performed in the spatial domain as illustrated in FIG. 3. First, the difference between the reference block (i.e. the blocks from the reference frame used for motion compensation of the current block) in the enhancement layer and the base layer is calculated:

D(t−1,n)=R(t−1,n)−R(t−1,0),

where D(t, n) denotes the difference for frame at time t and R(t, n) is the reconstructed pixel value at time t in layer n (spatial index is omitted for clarity). The resulting differential reference block is then scaled and added to the base layer reconstruction to create reference block P(t, n)

P(t,n)=R(t,0)+α*D(t−1,n),

which is then used as the reference for the current block FGS layer. The weight α is a parameter controlling the amount of information from the enhancement layer reference picture that is used for prediction. In general, the reference frame does not have to correspond to a time t−1 if multiple reference frames are used. It should be noted that, since this is a P-type macroblock and all the coefficients in the base layer are 0, the reconstructed base layer for the current block is exactly the same as the reconstructed reference block (at time t−1).

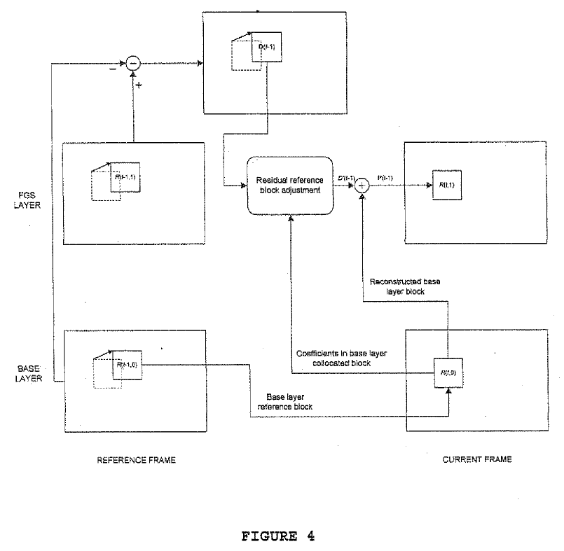

When there are non-zero coefficients in the base layer block, the enhancement layer coefficients are processed in the transform domain as illustrated in FIG. 4. For the coefficients which were non-zero in the base layer, no enhancement layer contribution from the reference frame is added. For the coefficients that have 0 values in the base layer, a similar weighted average as in the case of zero block is calculated, but this time in the transform domain. Thus, an additional step is introduced, in which the transform is performed on the reference difference block D(t−1, n), resulting in a block of transform coefficients FD(t−1, n). These coefficients are then further adjusted depending on the value of the base layer coefficients at corresponding locations in the current block FR(t, 0). The coefficients for which the corresponding base layer current block coefficients are 0 are also set to 0, whereas the coefficients corresponding to non-zero base layer current block coefficients are scaled by a weight β.

FD′(t−1,n)=β*FD(t−1,n),

The resulting block of coefficients is then inverse-transformed to obtain the differential reference block D′(t−1, n), which is finally added to the base layer reconstruction to create reference block P(t, n)

P(t,n)=R(t,0)+D′(t−1,n),

which is then used as the reference for the current block FGS layer.

The design described is based on a trade-off between compression efficiency, which is improved by utilising more information from the enhancement layer and the control of the prediction drift, which is aggravated by this process. It is argued that the impact of drift is smaller for the pixels/coefficients, for which the base layer does not change between the reference and current frame and therefore they can use enhanced reference. The parameter α is quantised to 5 bits and sent in the slice header as max_diff_ref_scale_for_zero_base_block. The parameter β is also quantised to 5 bits and sent in the same structure as max_diff_ref_scale_for_zero_base_coeff. The presence of both of them is controlled by the adaptive_ref_fgs_flag.

Further refinements in the use of the weighting factors are defined. The context-adaptive binary arithmetic coder (CABAC) coding context is used for further classification of the all-zero blocks. If the context is non-zero, it means that some neighbouring blocks have non-zero coefficients in the enhancement layer and thus the probability of coefficients becoming non-zero in the current block is higher. Therefore, the value of α is decreased so that less enhancement layer signal should be used to from prediction. For the case of blocks with non-zero coefficients in the base layer, the enhancement layer signal is only added when there are no more than 4 such coefficients and the value of β is adjusted depending on their number.

The present invention aims to improve the known adaptive-reference fine granularity scalability encoders and decoders, and does this in one aspect by taking advantage of further information available for adjusting the weighting of the components in the prediction.

According to the present invention there is provided an image sequence encoding/decoding apparatus/method in which the classification of the coefficients is improved by taking into consideration the probability of their corresponding reference block coefficients changing in the enhancement layer. This is based on the observation that the impact of dropping of the bits from the reference slice on the prediction mismatch in the areas where more coefficients change in the enhancement layer is stronger than in the areas where few or no coefficients change. While the reference block enhancement layer coefficients are not available to the decoder when the corresponding progressive refinement NAL unit has been dropped or truncated, this does not pose a problem, as the reference block adjustment is only performed when the block is available. Thus, no additional prediction mismatch is introduced by the proposed weight factor adjustment.

Embodiments of the invention will now be described, by way of example only, with reference to the accompanying drawings, in which:

FIG. 1 shows a block diagram of a quality-scalable video codec;

FIG. 2 shows reference block formation in non-adaptive FGS;

FIG. 3 shows reference block formation for an all-zero block;

FIG. 4 shows reference block formation for zero coefficients in a non-zero block;

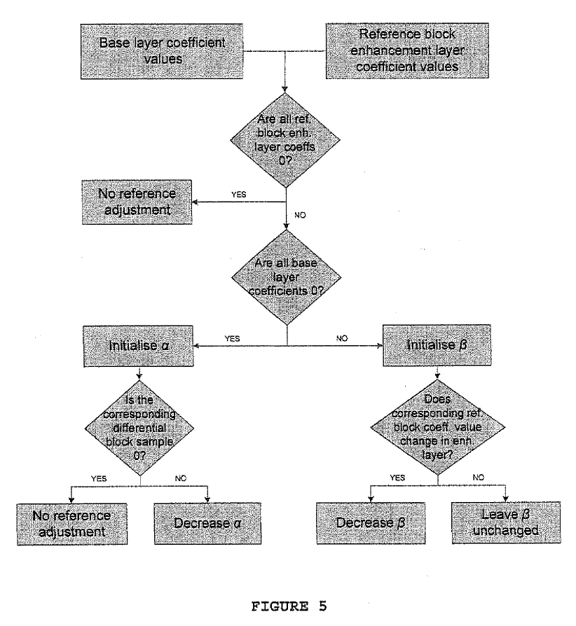

FIG. 5 shows a block diagram of the decision process in an embodiment; and

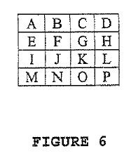

FIG. 6 illustrates a macroblock with 16 motion vectors in an embodiment.

The embodiments set out below may comprise hardware, software or a combination of hardware and software to perform the described processes. Accordingly, an embodiment may be attained by supplying programming instructions to a programmable processing apparatus, for example, as data stored on a data storage medium (such as an optical CD ROM, semiconductor ROM, magnetic recording medium, etc), and/or as a signal (for example an electrical or optical signal) input to the programmable processing apparatus, for example from a remote database, by transmission over a communication network such as the Internet or by transmission through the atmosphere.

Although the generation of a reference block in an encoder will be described below, the reference frame is generated in the same way in the decoder in embodiments of the invention.

### FIRST EMBODIMENT

The first embodiment of the present invention does not change the current technique for determining the values of the parameters α and β. Instead, they are treated as the initial values for the slice, and the embodiment performs further processing to adjust the values on a block basis depending on the characteristics of the reference block. More precisely, the weighting for the enhancement reference frame for blocks for which the reference block has few (no) coefficients changing in the enhancement layer, is increased. Conversely, this weighting is decreased from its initial value for blocks with many coefficients changing in the enhancement layer.

A specific implementation is as follows.

For the case when all coefficients are 0 in the base layer, the value of a is adjusted as follows:
1. If all the coefficients in the enhancement layer of the reference block are 0, the enhancement-layer reference block is identical to the base-layer current block and the value of α is immaterial. This is useful as it allows the omission of the computation of the weighted average for these blocks, thus reducing the complexity.
2. The same applies to pixels for which the impact of the coefficient change on the reconstructed pixel value is 0.
3. The value of the reconstructed sample of the reference blocks changes in the enhancement layer. In this case the same formula is used as in the current draft of MPEG-4 SVC, but the value of α is changed proportionally to the change in the magnitude of the reconstructed sample.

Depending on the complexity (memory) requirements, it may not be practical to separately consider the impact of coefficient enhancements on pixels in the reference block. In that case, case 2 is not treated separately and the calculation is performed in the same way as for case 3. Similarly, it may not be practical to adjust the weight on a per-pixel basis in case 3. In that case, the weight is adjusted based on the average magnitude of the change in the reconstructed sample value.

For the case when not all the coefficients are 0 in the base layer block, the weight β is adjusted as follows:
1. Similarly as in the case above, if all the coefficients in the enhancement layer of the reference block are 0, the difference block D(t−1, n) is zero and no adjustment of the base layer reference is needed.
2. If the coefficient changes in the reference block enhancement layer, the weighting of the reference block is decreased proportionally to the change in the value of the corresponding coefficient of difference block FD(t−1, n).
3. If the coefficient does not change, the weighting of the reference block is left unchanged.

Similarly as in the previous case, if computational complexity needs to be constrained, the adjustment of the weight β can be performed on a block basis, based on the average magnitude of the coefficient change. This is expected to be less of a problem than for the previous case because the processing is adjusted on a coefficient by coefficient basis anyway.

In both cases, an appropriate clipping is applied to the weighting factors to ensure that they remain in the allowed range. In a particular implementation, the adjustments for both cases are made in steps of 1/16 per unit difference in the pixel or coefficient value of the appropriate enhancement layer coefficient.

The decision process for the implementation described above is illustrated in FIG. 5.

In the described implementation, the adjustment is proportional to the magnitude of the change in the reference block enhancement layer. In an alternative implementation, the relationship may be nonlinear, including setting the value of the appropriate weighting factor to 0 or 1 if a predetermined threshold is reached.

### SECOND EMBODIMENT

Another aspect of adaptive-reference FGS is the complexity increase caused by the introduction of the second motion compensation/prediction loop. In an alternative implementation, the design is changed so that instead of weighted prediction, only a selection between base layer and reference picture enhancement layer is used, which means that only one of the two motion compensation processes needs to be invoked for a given block. Thus, there is no need to calculate the differential reference blocks D(t−1, n) and D′(t−1, n) as described above. Instead, the reference block P(t, n) is simply a copy of either the base layer block R(t, 0) or the enhancement layer reference block R (t-1, n) depending on whether there are any non-zero coefficients in the base layer reference block. More particularly, the reference block P(t, n) is a copy of the enhancement layer reference block R (t−1, n) if all the coefficients in the base layer reference block are zero, while it is a copy of the base layer block R(t, 0) if not all of the coefficients in the base layer reference block are zero.

To offset the loss of precision caused by coarser quantisation of the weights, the alternative implementation uses a finer granularity of their adjustment, where the weights are changed per block rather than per slice.

In one implementation, the weights are adjusted based on the characteristics of signal that are known to both the encoder and decoder, which means that no explicit signalling is required on a macroblock level.

In an alternative implementation, the flags are sent in the bitstream. While this has a cost in the bandwidth required, it is not very significant if efficient entropy coding is employed, particularly at the higher bitrates. In addition to helping improve the coding efficiency, this variant also allows the implementation of “partial decoder refresh”. That is, the effect of the prediction drift can be controlled on a macroblock by macroblock basis, thus limiting its impact on coding efficiency and particularly reducing the visual impact perceived when a whole frame is encoded with lower compression efficiency.

### THIRD EMBODIMENT

In a third embodiment, the weights α and β are adapted based on the properties of the motion field in the vicinity of the currently processed block. Specifically, the motion vectors of the surrounding blocks are compared to the motion vector of the current block and the weights are adjusted based on a measure of difference between them. In one implementation, the measure used is based on the magnitude of the difference of the current block motion vector and the surrounding motion vectors. This magnitude can be calculated as the average squared difference of the current motion vectors and the surrounding motion vectors, i.e.:

$$M = \frac{1}{N} {\sum }_{i = 0}^{N} \{ {( {v}_{x}^{i} - {v}_{x}^{c} )}^{2} + {( {v}_{y}^{i} - {v}_{y}^{c} )}^{2} \} ,$$

where N is the number of surrounding blocks taken into consideration, v^{c} is the motion vector of the current block, vⁱ is the motion vector of the i-th surrounding block, and x and y denote the components of the motion vectors. Other measures of difference can also be used. One example is a similar formula as above, with the exception that square root of the magnitude is used in the summation, i.e.

$${M}^{′} = \frac{1}{N} {\sum }_{i = 0}^{N} \{ \sqrt{{( {v}_{x}^{i} - {v}_{x}^{c} )}^{2} + {( {v}_{y}^{i} - {v}_{y}^{c} )}^{2}} \} .$$

The amount of adjustment can be specified to be proportional to the value of the difference measure used. Alternatively non-linear dependency can be specified, including specification of a look-up table for the values of adjustment depending on the value of the difference measure. A specific example of a look-up table is as follows:
Decrease weight by 6/32 if M>64
Otherwise, decrease weight by 4/32 if M>32
Otherwise, decrease weight by 3/32 if M>16
Otherwise, decrease weight by 2/32 if M>8
Otherwise, decrease weight by 1/32 if M>0.

When no motion vectors are transmitted (so-called SKIP macroblock, where no motion vectors or transform coefficients are sent and the macroblock from the previous frame is simply copied over), it is impossible to calculate the measure of difference as defined above. Since this indicates that there is little change between the previous and current frame at the current macroblock position, the weight can be either left unchanged or increased in this case.

The selection of the set of the surrounding blocks to be used in the calculation of the measure of difference depends on complexity considerations, the position of the current macroblock in the frame and the position of the current block in the current macroblock.

In order to limit the complexity, the first implementation only uses the blocks within the current macroblock for the calculation of the measure of difference. The maximum number of motion vectors in a macroblock is 16 (one for each of the 4×4 blocks). Depending on the position of the block within the macroblock, the number of surrounding blocks then varies between 3 and 8 (top, left, right, bottom, top-left, top-right, bottom-left and bottom-right), depending on the position of the block in the macroblock. This is illustrated in FIG. 6, where the blocks labelled A, D, M and P have 3 available surrounding blocks, B, C, E, H, I, L, N and O have 5 available surrounding blocks, and F, G, J and K have 8 available surrounding blocks each. The cases where fewer than 16 motion vectors are used can be treated similarly, by copying treating the motion vectors corresponding to larger (e.g. 8×8) blocks as if they were a corresponding number (e.g. 4) motion vectors for the corresponding 4×4 blocks.

In a second implementation, the information from all or some of the previously processed macroblocks (top-left, top, top-right and left to the current macroblock) is also used in the calculation of the measure of difference. This means that additional blocks become available for the calculation of the measure of difference for the blocks A, B, C, D, E, I and M in FIG. 6. When all the previously processed macroblocks are used, blocks A, B, C, E and I have 8 available surrounding blocks, block D has 6 available surrounding blocks and block M has 5 available surrounding blocks.

In an alternative implementation, the measure of difference is adjusted to take into consideration the distance between the current block and each of the surrounding blocks. For example, using the set of blocks shown in FIG. 6, and taking block F as the current block, the blocks B, E, G and J are used with more weight than blocks A, C, I and K.

A simplified implementation calculates the measure of distance only once for the whole macroblock and then uses this value for all the blocks within the macroblock.

### Modifications

Many modifications can be made to the embodiments described above within the scope of the accompanying claims.

For example, in an alternative implementation, the value of the adjustment of the weighting parameters is based on a combination of factors, one of which is the change of the values of the reference block enhancement layer coefficients described above. These other factors can be, for example, the macroblock type and prediction modes or the arithmetic coder coding context as described in the prior art. More specifically, the adjustments can simply be added together to form the total adjustment, where the adjustments from different factors may have different granularity.

In another alternative implementation, the strength of the modification of the weighting factor depends on its initial value. More precisely, if the initial value of the weighting factor is small, the changes are also small and as the initial value increases the changes are allowed to be made larger. This is done in order to allow for better control of the drift. When the drift is a problem (e.g. long distance between intra pictures), it is more important to be able to control its strength with higher precision. More precisely, such a scheme is implemented by scaling the change by the initial value of the weight. That is, instead of changing the weights α and β by fixed amount (e.g. 1/16), they are changed by an amount proportional to the initial value obtained from the bitstream elements max_diff_ref_scale_for_zero_base_block and max_diff_ref_scale_for_zero_base_coeff, e.g.:

α=(1+γ)α₀,

where α₀ is the initial value of the weight and γ is the strength of adjustment based on the change of magnitude as described above. If adjustments from multiple factors are combined, the formula can be expanded to e.g.;

α=(1+γ)(1+δ)α₀,

where γ and δ are the contributions corresponding to the different factors, e.g. enhancement layer coefficient magnitudes, arithmetic coder coding context, or macroblock type and prediction mode.

This is just one example of non-uniform quantisation of the weight values, more general schemes could also be considered. For example, the quantisation step used in the quantisation of the block transform coefficients has a significant impact on the drift properties. In an alternative implementation, the calculation of adjustment of the weights takes this into account.

When only a part of the FGS layer is received by the decoder, the quality of the decoding can be improved if the amount of the data available as proportion of the total amount of data in the FGS layer is known or estimated. In that case, the amount of adjustment of the weight values can be additionally adjusted to correspond more closely to the optimal weighting.

1-49. (canceled)

50. A method of generating enhancement layer prediction data in an adaptive reference fine granularity scalability encoder or decoder, the method comprising:
receiving data for a plurality of image frames; and
processing the data to form prediction data using a weighted combination of base layer data and difference data, with the amount of weighting being dependent upon properties of a motion field in the vicinity of a currently processed block.

51. A method according to claim 50, wherein the weighting is dependent upon the magnitudes of differences in the motion field.

52. A method according to claim 50, wherein the difference data comprises a difference between reference block data in the enhancement layer and the base layer.

53. A method according to claim 50, wherein the difference data comprises transformation coefficients defining transformation differences between reference block data in the enhancement layer and the base layer.

54. A method according to claim 50, wherein the prediction data is generated by:
generating reference data by combining data in accordance with scaling parameters such that the scaling parameters are set in dependence upon differences between motion vectors of a currently processed block and motion vectors of at least one surrounding block; and
generating the prediction data in dependence upon the generated reference data.

55. A method according to claim 50, wherein a block of data is processed by:
calculating a weighting factor for use in combining difference data with base layer data;
comparing motion vectors of the block with motion vectors of a plurality of surrounding blocks to determine differences therebetween;
adjusting the weighting factor in dependence upon the differences between the motion vectors;
combining the difference data and the base layer data in accordance with the adjusted weighting factor to generate reference data; and
generating enhancement layer prediction data using the generated reference data.

56. A method according to claim 55, wherein the weighting factor is adjusted in linear dependence upon the differences between the motion vectors.

57. A method according to claim 54, wherein:
the reference data is generated by:
calculating a difference between reference data in the enhancement layer and reference data in the base layer to generate differential reference data;
comparing motion vectors of a current block with motion vectors of a plurality of surrounding blocks to calculate a measure of the motion vector differences;
scaling the differential reference data in dependence upon the calculated motion vector difference measure to generate scaled differential reference data; and
combining the scaled differential reference data with base layer reconstructed data;
and wherein the reference data is compared with base layer data to generate prediction error data.

58. A method according to claim 54, wherein:
the reference data is generated by:
calculating a difference between reference data in the enhancement layer and reference data in the base layer to generate differential reference data;
transforming the differential reference data to generate transform coefficients;
comparing motion vectors of a current block with motion vectors of a plurality of surrounding blocks to calculate a measure of the motion vector differences;
scaling the transform coefficients in dependence upon the calculated motion vector difference measure to generate scaled transform coefficients;
inverse-transforming the scaled transform coefficients to obtain modified differential reference data; and
combining the modified differential reference data with base layer reconstructed data;
and wherein the reference data is compared with base layer data to generate prediction error data.

59. A method according to claim 57, wherein the process of comparing motion vectors comprises comparing motion vectors of the currently processed block with motion vectors of surrounding blocks in the same macroblock.

60. A method according to claim 59, wherein the process of comparing motion vectors comprises comparing motion vectors of the currently processed block with motion vectors of surrounding blocks in the same macroblock and also motion vectors of at least one previously processed macroblock.

61. A method according to claim 57, further comprising weighting the differences between the motion vectors of the currently processed block and each surrounding block in dependence upon a measure of the distance between the currently processed block and the surrounding block.

62. A method according to claim 61, wherein the differences between the motion vectors are weighted such that motion vector differences between blocks with a smaller distance therebetween contribute more to the motion vector difference measure than differences between the motion vectors of blocks with a larger distance therebetween.

63. An adaptive reference fine granularity scalability encoder or decoder operable to generate enhancement layer prediction data, comprising:
a receiver operable to receive data for a plurality of image frames; and
a data processor operable to process the data to form prediction data using a weighted combination of base layer data and difference data, with the amount of weighting being dependent upon properties of a motion field in the vicinity of a currently processed block.

64. Apparatus according to claim 63, wherein the weighting is dependent upon the magnitudes of differences in the motion field.

65. Apparatus according to claim 63, wherein the difference data comprises a difference between reference block data in the enhancement layer and the base layer.

66. Apparatus according to claim 63, wherein the difference data comprises transformation coefficients defining transformation differences between reference block data in the enhancement layer and the base layer.

67. Apparatus according to claim 63, wherein the data processor comprises:
a reference data generator operable to generate reference data by combining data in accordance with scaling parameters such that the scaling parameters are set in dependence upon differences between motion vectors of a currently processed block and motion vectors of at least one surrounding block; and
a prediction data generator operable to generate prediction data in dependence upon the generated reference data.

68. Apparatus according to claim 63, wherein the data processor comprises:
a weighting factor calculator operable to calculate a weighting factor for use in combining difference data with base layer data;
a motion vector comparer operable to compare motion vectors of a block of data with motion vectors of a plurality of surrounding blocks to determine differences therebetween;
a weighting factor adjuster operable to adjust the weighting factor in dependence upon the differences between the motion vectors;
a data combiner operable to combine the difference data and the base layer data in accordance with the adjusted weighting factor to generate reference data; and
a prediction data generator operable to generate enhancement layer prediction data using the generated reference data.

69. Apparatus according to claim 68, wherein the weighting factor adjuster is operable to adjust the weighting factor in linear dependence upon the differences between the motion vectors.

70. Apparatus according to claim 67, wherein:
the reference data generator comprises:
a difference calculator operable to calculate a difference between reference data in the enhancement layer and reference data in the base layer to generate differential reference data;
a motion vector comparer operable to compare motion vectors of a current block with motion vectors of a plurality of surrounding blocks to calculate a measure of the motion vector differences;
a data scaler operable to scale the differential reference data in dependence upon the calculated motion vector difference measure to generate scaled differential reference data; and
a data combiner operable to combine the scaled differential reference data with base layer reconstructed data;
and wherein the prediction data generator is operable to compare the reference data with base layer data to generate prediction error data.

71. Apparatus according to claim 67, wherein:
the reference data generator comprises:
a difference calculator operable to calculate a difference between reference data in the enhancement layer and reference data in the base layer to generate differential reference data;
a transform coefficient generator operable to transform the differential reference data to generate transform coefficients;
a motion vector comparer operable to compare motion vectors of a current block with motion vectors of a plurality of surrounding blocks to calculate a measure of the motion vector differences;
a data scaler operable to scale the transform coefficients in dependence upon the calculated motion vector difference measure to generate scaled transform coefficients;
an inverse transformer operable to inverse-transform the scaled transform coefficients to obtain modified differential reference data; and
a data combiner operable to combine the modified differential reference data with base layer reconstructed data;
and wherein the prediction data generator is operable to compare the reference data with base layer data to generate prediction error data.

72. Apparatus according to claim 70, wherein the motion vector comparer is operable to compare motion vectors of the currently processed block with motion vectors of surrounding blocks in the same macroblock.

73. Apparatus according to claim 72, wherein the motion vector comparer is operable to compare motion vectors of the currently processed block with motion vectors of surrounding blocks in the same macroblock and also motion vectors of at least one previously processed macroblock.

74. Apparatus according to claim 70, further comprising a weighting calculator operable to weight the differences between the motion vectors of the currently processed block and each surrounding block in dependence upon a measure of the distance between the currently processed block and the surrounding block.

75. Apparatus according to claim 74, wherein the weighting calculator is operable to weight the differences between the motion vectors such that motion vector differences between blocks with a smaller distance therebetween contribute more to the motion vector difference measure than differences between the motion vectors of blocks with a larger distance therebetween.

76. A storage medium storing computer program instructions to program a programmable processing apparatus to become operable to perform a method as set out in any one of claims 50 to 62 and 77.

77. A method according to claim 50, wherein the data is processed to form the prediction data using a weighted combination of base layer data and difference data such that the weighting is dependent upon a measure of differences in the motion filed and such that the weighting decreases with increasing differences.

78. Apparatus according to claim 63, wherein the data processor is operable to process the data to form the prediction data using a weighted combination of base layer data and difference data such that the weighting is dependent upon a measure of differences in the motion filed and such that the weighting decreases with increasing differences.
